(19) United States
(12) Patent Application Publication
(10) Pub. No.: US 2007/0288453 A1
(43) Pub. Date: Dec. 13, 2007

(54) System and Method for Searching Multimedia using Exemplar Images

(75) Inventor: Christine Podilchuk, Warren, NJ (US)

Correspondence Address: CATALINA & ASSOCIATES;A Professional Corporation, 2355 HIghway 33, Robbinsville, NJ, 08691, US

(73) Assignee: D&S CONSULTANTS, INC., Eatontown, NJ (US)

(21) Appl. No.: 11/619,133

(22) Filed: Jan. 2, 2007

Related U.S. Application Data
(60) Provisional application No. 60/812,646, filed on Jun. 12, 2006.
(60) Provisional application No. 60/816,686, filed on Jun. 27, 2006.
(60) Provisional application No. 60/861,685, filed on Nov. 29, 2006.
(60) Provisional application No. 60/861,932, filed on Nov. 30, 2006.
(60) Provisional application No. 60/873,179, filed on Dec. 6, 2006.

(51) Int. Cl. G06F 17/30

(52) U.S. Cl. 707/5

(57) ABSTRACT

A system and method of searching multimedia databases using key images that returns image content ranked by degree of similarity to the key-images. A user accesses the search engine via a graphic user interface (GUI) that allows the user to enter key-images using drag-and-drop technology. The user may also enhance the description of the key-images using text based input, or used text based input to call up exemplary images. The user may also use Boolean logic to combine the key-images, and the key-images and text input, into search strings. The search strings may then be used to find matches from pre-indexed directories that have been created by analyzing content in advance.

### CROSS REFERENCE TO RELATED APPLICATIONS

This application is related to, and claims priority from, U.S. Provisional Patent application No. 60/861,686 filed on Nov. 29, 2006 by C. Podilchuk entitled “Method for multimedia information retrieval using a combination of text and exemplar images in the query”, the contents of which are hereby incorporated by reference.

### FIELD OF THE INVENTION

The present invention relates to systems and methods for searching databases, and more particularly, to systems and methods for searching multimedia databases using exemplar images.

### BACKGROUND OF THE INVENTION

A conventional search engine is a document retrieval system designed to help find information stored in one or more databases that are typically part of one or more websites.

Search engines, such as, the Google™ engine provide by Google, Inc. of Mountain View, Calif. and the Yahoo!™ engine provided by Yahoo! Of Sunnyvale, Calif. are used by millions of people each day to search for information on the World Wide Web. Such search engines enable a user to query the databases using one or more keywords that may be combined into a search string using Boolean logic. The search engine returns a list of documents having content that meets the user's request, i.e., the documents contain the keywords in the combination specified by the search string. The documents are usually listed in order of the relevance of the results, as determined by some metric of relevance such as, but not limited to, Google's well-known Page ranking method. The unique resource locator (URL) of each document is also typically displayed. Advertising, or links to advertisers' sites, having content that may be based on the keywords in the search string is also often displayed along side the search results. This form of advertising has become very widely used and is an extremely rich source of revenue for the search engine suppliers.

As more users gain access to the Internet via high-bandwidth connections, websites that are rich in image content, including video and photographs, are becoming more common and more important. This trend may be seen in the rapid rise in popularity of, for instance, Google Inc's YouTube™ website and Yahoo! Inc's Flickr™ website. The YouTube website features short video clips that are typically homemade and uploaded by the users. Flickr is a site for storing and sharing photographs. A problem with websites that have image rich content is that conventional search engines are text based and, therefore, not able to search the image content. Both YouTube and Flickr attempt to solve this problem by having users add text tags and/or text annotations to the images and video. The conventional search engines may then do conventional searching on the text that is associated with the image.

One short coming of the keyword tag approach to searching image databases is that it requires human intervention. A second short coming is that it does not allow searching for an image, i.e., looking for an image that matches, or is similar to, an example image. The potential importance of being able to search for an image may be illustrated by considering the following scenario. A YouTube user sees a clip of a celebrity on a TV show and likes the handbag the celebrity is carrying. The YouTube user would like to buy the same model of handbag, and has even downloaded an image of the handbag, but doesn't know where to begin looking. A search on the internet for, for instance, the key words “Kelly Ripa” and “handbag” turns up hundreds of sites, dozens of which are handbag manufacturers' sites that claim Kelly has been seen wearing their handbags. The problem is the sites each have dozens of handbags and there is no indication of which site may have the closest match or, better still, which page on which site may have the closest match. So the YouTube user has to manually sort through hundreds of images of handbags on dozens of pages to hopefully find a match. What would be more useful to such a user is a system that allowed them to somehow enter the image of the handbag they have downloaded and then automatically have pages that contain a matching or similar image delivered, preferably with a reliable ranking system that indicates how similar each of the images contained in the pages is to the example image.

There are a few image search systems which attempt to provide the ability to search for matches to example images using attributes from the images themselves. These methods are called Content Based Image Retrieval (CBIR) methods and have been described in detail in, for instance, U.S. Pat. No. 5,751,286 to Barber, et al. issued on May 12, 1998 entitled “Image query system and method”, the contents of which are hereby incorporated by reference. The attributes that have been used in such systems include, but are not limited to, color layout, dominant color, homogeneous texture, edge histogram, shape region, and shape contour. Most CBIR systems allow the user to input qualitative values for things such as color, texture and low level shape descriptors. A drawback of such existing systems is that these attributes are frequently not known by users. A further drawback is that ranking images in order of the most likely match in such systems is heavily dependent on the weight given to different attributes, making consistent results difficult to attain.

An image search system that does not rely on users supplied text tags and can consistently find good matches from easily entered data may be of great importance in fields from Internet shopping, to browsing photo and video content, including surveillance tapes.

### SUMMARY OF THE INVENTION

Briefly described, the present invention provides a system and method of searching multimedia databases using key-images that rapidly returns image content that is consistently ranked by degree of similarity to the key-images.

In a preferred embodiment, a user accesses a key-image based search engine via a graphic user interface (GUI) that allows the user to enter key-images using drag-and-drop technology. The user may also enhance the description of the key-images using text based input, or used text based input to call up exemplar images. The user may also use Boolean logic to combine the key-images, and the key-images and text input, into search strings. The search strings may then be used to find matches from pre-indexed directories.

In a preferred embodiment, the pre-indexed directories have been created by analyzing content in advance. For instance, video footage may first be analyzed by software capable of detecting particular classes of objects such as, but not limited to, a face detector. Once the positions of all faces in the video have been detected, these may then be examined more closely to check for particular people. The result of these computations may then be used to form a similarity matrix and frame location index that may be stored in the directory for later retrieval.

The system and method of this invention may be of considerable use in the fields of, for instance, surveillance, entertainment and anywhere biometrics are applied including, but not limited to, comparison of fingerprints, iris images and face-prints.

These and other features of the invention will be more fully understood by references to the following drawings.

### BRIEF DESCRIPTION OF THE DRAWINGS

FIG. 1 is a schematic drawing showing an exemplary embodiment of a system for searching multimedia using exemplar images.

FIG. 2 is a schematic drawing of an Image Connection Engine (ICE).

FIG. 3 is a schematic drawing of a Graphic User Interface (GUI) used in an exemplary embodiment of a system for searching multimedia using exemplar images.

FIG. 4 is a flow diagram showing steps in using a system for multimedia searching using exemplar images.

FIG. 5 is a flow diagram showing steps in forming an indexed database in an exemplary embodiment of a system for searching multimedia using exemplar images.

FIG. 6 is a flow diagram showing steps in responding to a search request in an exemplary embodiment of a system for searching multimedia using exemplar images.

### DETAILED DESCRIPTION

The present invention relates to systems and methods for searching multimedia databases.

In a preferred embodiment, the system and method of this invention allows keywords and key-images to be combined into search strings using Boolean operators. These search strings may then be used to rapidly find a targeted image, video clip or document containing images, or close matches to that target, in a multimedia database. For instance, the system of this invention allows a search string to specify that the desired image contains an image, or person, shown in a first key-image and also the person in a second key-image but not the person shown in a third key-image.

In addition, keywords may be used to specify a generic class. For example, a query may specify that a target image, or video clip, contains the person in the key-image and the person or object that a keyword represents. The keyword may, for instance, be “suitcase”. The result of the search will then be images of suitcases. Such queries may be helpful in, for instance, searching surveillance or other videos.

Another example of a possible query would be to request all images of men appearing from eleven to twelve at night at a certain intersection in New York City.

Such searches may be of considerable use in applications related to surveillance, entertainment and anywhere biometrics are applied including, but not limited to, comparison of fingerprints, iris images and face-prints. Such a search system may, for instance, be used as an augmentative aid to reduce the cognitive load of law enforcement personal including, but not limited to, soldiers and security guards.

The system and method of this invention that allows the use key-images as well as keywords in searching multimedia databases may be called a Pictorial Language Using Trained Ontologies (PLUTO).

In a preferred embodiment, a user interacts with a PLUTO search engine by means of a graphical user interface (GUI). The GUI allows the user to interface to the pre-computed similarity matrices and pre-computed classes of objects that are part of the PLUTO infrastructure. The infrastructure may also include an Image Connection Engine (ICE) that may contain further similarity matrices and the object class recognizers. The object class recognizers may, for instance, be one or more trained support vector machine each trained to recognize a particular class of object such as, but not limited to, faces, cars, people, trees, plants, animals, aircraft, consumer goods and electronic devices.

In a preferred embodiment, a multimedia asset such as, but not limited to, a video clip may first be examined by such a general class recognizer running, for instance, a face detection algorithm. The general class recognizer may, for instance, be a trained support vector machine or a trained similarity inverse matrix (SIM) learning system as described in, for instance, co-pending U.S. patent application Ser. No. 11/619,121 by C. Podilchuk on Jan. 2, 2007 entitled “System and Method for Machine Learning using a Similarity Inverse Matrix”, the contents of which are hereby incorporated by reference. The face detector may examine the entire video sequence to identify video frames in which faces are detected, and to locate which regions of those video frames contain the face. These regions can then be checked using a more comprehensive similarity matrix to detect if a particular person may be identified at that location. These computations may be preformed in advance to produce a similarity matrix and frame location index.

This similarity matrix can then be searched to find matches to image based query stings using, for instance, fast search algorithms and methods as described in detail in co-pending application Ser. No. 11/619,109 filed on Jan. 2, 2007 by C. Podilchuk entitled “System and Method for Rapidly Searching a Database”, the contents of which are hereby incorporated by reference. The fast search method detailed in this reference is hereafter referred to as a Podilchuk similarity matrix fast search.

The image connection engine functions, in some respects, in a manner similar to web-crawlers (a.k.a. spiders or robots). These web-crawlers are software agents that automatically visit sites on the World Wide Web and examine them by, for instance, counting the number of keywords on each page. These keyword counts may then be complied into a large similarity matrix which is then used to compute an index and directory for future searches.

One of ordinary skill in the art will readily appreciate that the searching system of this invention may be used to search websites, specific domains, specific computer or specific files, whether they are accessed directly or over a network such as, but not limited to, the Internet, the public telephone network a cable network system, or some combination thereof.

A preferred embodiment of the invention will now be described in detail by reference to the accompanying drawings in which, as far as possible, like elements are designated by like numbers.

Although every reasonable attempt is made in the accompanying drawings to represent the various elements of the embodiments in relative scale, it is not always possible to do so with the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

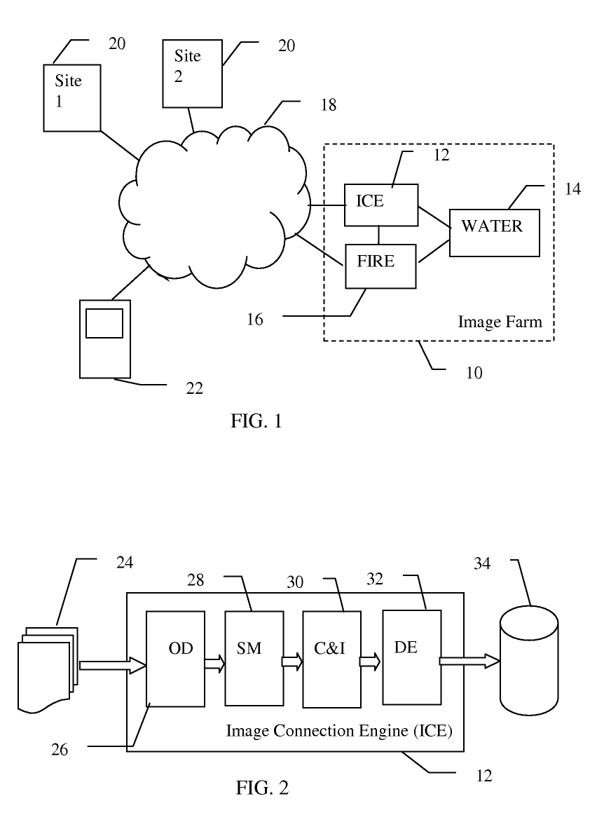

FIG. 1 is a schematic drawing showing an exemplary embodiment of a system for searching multimedia using exemplar images. The system includes an image farm 10 that may include an Image Connection Engine (ICE) 12, a Working Archive Tabulated for Efficient Retrieval (WATER) 14 and a Fast Image Retrieval Engine (FIRE) 16. The image farm 10 may be connected to a network 18 that may, for instance, be the World Wide Web. Websites 20 may also be connected to the network 18, as may a system user 22. The websites 20 may, for instance, contain multimedia content residing on a computer or computer memory and accessible by means of one or more unique resource locators (URL). The system user 22 may, for instance, be a browser, operated by a user that is running on a computer connected to the network 18. The Image Connection Engine (ICE) 12 may be one or more software programs running on a computer that is connected to the network 18. The Image Connection Engine (ICE) 12 may, for instance, download multimedia content from one or more of the websites 20 and examine the image and video content for the purposes of identifying and classifying the image and video content. Once the content has been identified and classified, representative images may be stored on the Working Archive Tabulated for Efficient Retrieval (WATER) 14 in a directory that may reside on a computer or computer memory. The directory may include, but is not limited to, one or more similarity matrices and indices to the similarity matrices. The Fast Image Retrieval Engine (FIRE) 16 may be a software program such as, but not limited to, a server running on a general purpose digital computer, that enables queries submitted by one or more system users 22 to be processed. The processing of the queries may alternatively be undertaken by the Image Connection Engine (ICE) 12, or a combination thereof.

FIG. 2 is a schematic drawing of an Image Connection Engine (ICE) 12. The ICE module 12 processes images 24 that may be received or obtained from websites 20 over a network 18. An object detector module 26 may be a software module running on general purpose computer and may be the first module to examine images received or obtained by the ICE module 12. The object detector module 26 may detect the presence of particular classes of objects in an image. The object detector module 26 may, for instance, be an SVM machine, or a SIM machine, trained to detect, for instance, a face, a car, a suitcase, a type of animal, a type of plant or some other type of object. Once an object is detected, its location in the image may be noted. The image of the object may also be resized, and adjusted for brightness.

A similarity matrix module 28 may be the next module to examine images received or obtained by the ICE module 12. The similarity matrix module 28 may for instance, be a software module running on a general purpose digital computer. The similarity matrix module 28 may, for instance, operate on the resized and brightness adjusted images of the various object classes obtained by the object detector module 26. For each of the classes, the similarity matrix module 28 may, for instance, construct a similarity matrix using, for instance, a similarity metric such as, but not limited to the P-edit distance (a.k.a. the pictorial edit distance or the image edit distance). The image edit distance, and its use in generating a similarity matrix, is described in detail in, for instance, co-pending U.S. patent application Ser. No. 11/619,092 submitted by C. Podilchuk on Jan. 2, 2007 entitled “System and Method for Comparing Images using an Edit Distance”, the contents of which are hereby incorporated by reference.

An image clustering and indexing module 30 may be the next module to process the images 24 received or obtained by the ICE module 12. The image clustering and indexing module 30 may, for instance, be a software module running on a general purpose digital computer. The image clustering and indexing module 30 may operate on the similarity matrix and indices generated by the similarity matrix module 28 to cluster and index the images in the particular classes of objects so that the similarity matrices may be more rapidly searched.

A directory enrollment module 32 may be the next module to operate on images received or obtained by the ICE module 12. The directory enrollment module 32 may, for instance, be a software module running on a general purpose digital computer. The directory enrollment module 32 may operate on new images in a class, or new instances of a class, and ensure that that are added to a directory and that they are appropriately indexed when added.

A directory 34 may be a general purpose digital information storage such as, but not limited to, a magnetic or optical disk storage unit. The directory 34 may be where the various module of the ICE module 12 and Fast Image Retrieval Engine (FIRE) 16 store their data and results including, but not limited, to the similarity matrices and indices generated for the various classes of objects.

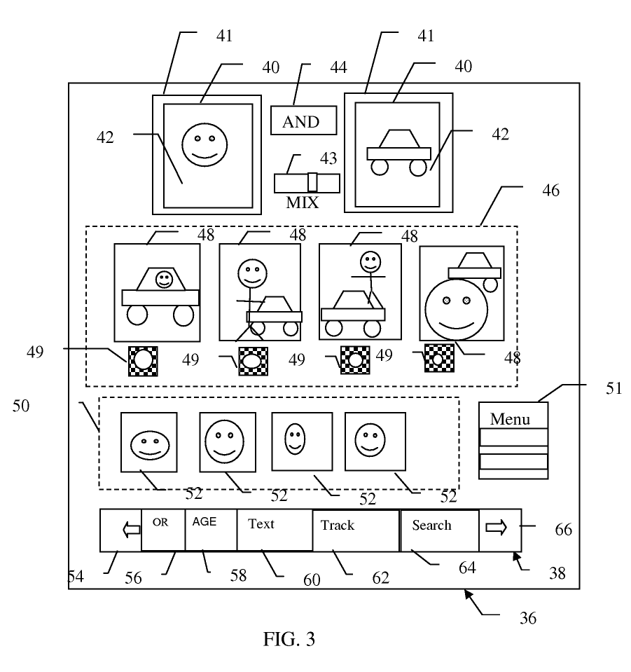

FIG. 3 is a schematic drawing of a Graphic User Interface (GUI) used in an exemplary embodiment of a system for multimedia searching using exemplar images.

The GUI 36 may be generated by a software package running on general purpose digital computer. The GUI 36 may be displayed on a computer display such as, but not limited to, a light emitting diode (LED) or plasma display. The GUI 36 may contain a control ribbon 38 displaying icons that allow the user to activate particular functions, or views of the GUI 36, by, for instance, using a well known computer mouse to position a cursor over the icon and then performing some action such as, for instance, clicking or double clicking a mouse button. Interaction with the GUI 36 may also, or instead, be effected using speech recognition of audible commands or by user interaction with a well-known touch sensitive screen.

The GUI 36 may contain one or more key-picture entry areas 40, one or more Boolean operator entry areas 44, and results area 46 that may contain one or more result images 48, and a working area 50.

A user may interact with the GUI 36 by, for instance, first displaying a set of working images 52 in the working area 50. The working images 52 may, for instance, be images that a user has stored on a hard-drive or other similar computer peripheral. The working images 52 may be, but are not limited to, images the user has previously downloaded from websites, taken with a digital camera or created using a suitable digital image generation and manipulation software package, or some combination thereof. The user may then transfer a copy of one of the working images 52 to the key-picture entry area 40 by, for instance, using a computer mouse controlled cursor to drag-and-drop the image into the key-picture entry area 40.

Once the working images 52 is in the key-picture entry area 40 it may be considered to be a key-image 42. Attributes of the key-image 42 may be altered or added to by the user by, for instance, using one of the icons on the control ribbon 38 or by entering text into the key-picture entry area 40 over the key-image 42, or by some combination of this. For instance, the key-image 42 may be a face and the user may change an attribute such as, but not limited to, the hair color or style by overtyping the text “black hair”, or “crew-cut hairstyle”. The key-image 42 may then be updated to reflect the changes or the altered attributes may simply be used by the ICE module 12 when searching the similarity matrices and indexes in the directory 34.

The user may, for instance, initiate a search for other images that contain or are similar to the key-image 42 by, for instance, pushing a search icon 64 on the control ribbon 38 or issuing a voice command or some other suitable method of interacting with the GUI 36. The key-image 42 is then sent to the ICE module 12 where a search is performed. The result images 48 are then returned and displayed in the results area 46. The result images 48 may be ordered in a degree of similarity they possess to the key-image 42 or by date they were posted, or some combination thereof. The number of result images 48 may be pre-determined by the user. If there are more result images 48 than can be displayed in the results area 46, the GUI 36 may enable the user to view them in a series of pages or to scroll through a sequence of them. The result images 48 may be displayed as thumbnails of the originals and may have URLs linking them to the original or an achieved copy of the original.

Instead of searching on a single key-image 42, the user may elect to use one or more further key-images 42. These may be added to a key-picture entry area 40 by dragging and dropping or by adding text to the key-picture entry area 40, or by use of a suitable icon on the control ribbon 38 or some combination thereof. For instance, a generic version of a common object such as, but not limited to, a car, a person, a tree, a dog, a cat, a jet aircraft, a computer, a suitcase, a newspaper or a coffee mug, may be obtained simply by typing in the appropriate keyword. A picture of the generic object may be displayed in the key-picture entry area 40 or the keywords may simply be transmitted to the ICE module 12 as part of a search string. The user may relate the one or more key-images 42 using one or more Boolean operators entered into the Boolean operator entry areas 44. For instance, the default operator may be a Boolean AND operator that results in the ICE module 12 returning result images 48 that contain both key-images 42 currently selected.

The Boolean and other image operations may also or instead be indicated in the query by overlaying translucent images, cutting and pasting solid images and by adding color to an image border 41. A green image border 41 may for example indicate a Boolean AND operator, i.e., that the image with the green image border 41 is to be included in the search string. A red image border 41 may, for instance indicate a Boolean NOT operator, i.e., that the image with the red image border 41 is to be included the search string in order that results do not include composite images that have this sub-image, or a close match to it. An orange image border 41 may, for instance, indicate an OR. Coloring the image border 41 may, for instance, be accomplished by a pop-up menu activated on moving a curser over the image border 41 or by voice command or some suitable button, menu or keyboard command.

Search strings may consist of combinations of key-images and keywords joined by any of the common Boolean operators including, but not limited to, AND, NOT, OR and the exclusive OR operators.

The result images 48 may be displayed along side a match indictor 49. The match indictor 49 may, for instance be indicate the similarity score by displaying a thumbnail image in which the pixels that are changed are, for instance, white and the unchanged pixels black, or vice versa. Such an image may provide a quick visual indication of how similar the input image was to a search query or a selected image. The result images 48 may also or instead be a numerical score, or a graphic fuel gauge or some combination thereof.

In a further method of using the GUI 36, a user may select to track objects through a video sequence. The user may, for instance, select a track icon 62 from the control ribbon 38, a video clip from a directory using a menu 51 and a key-image 42. This may cause the ICE module 12 or Fast Image Retrieval Engine (FIRE) 16 or a combination thereof, to track occurrences of the key-image 42 through the video clip. The tracking may, for instance be done using a system such as the co-pending U.S. patent application Ser. No. 11/619,083 filed by C. Podilchuk on Jan. 2, 2007 entitled “Target Tracking using Adaptive Target Updates and Occlusion Detection and Recovery” the contents of which are hereby incorporated by reference. Such tracking of an object in sequential and interrupted frames of video may reduce the overhead of recognizing objects and of indexing individual frames.

In a further method of using the GUI 36, a user may apply Unary operations to the key-image 42 such as, but not limited to, aging or de-aging a face or other object. This may, for instance be initiated using an age icon 58 on the control ribbon 38. Selecting the age icon 58 may for instance, produce a pop up menu allowing the selection of a target age or a number of years to age. The aging may, for instance be done by suitably trained support vector machines or by trained SIM learning engines. Other unary operations that used may applying include a warp function that may be selected from the control ribbon 38 and allow a user to warp a key-image 42 by pulling and/or compressing parts of the key-image 42 using, for instance a curser controlled by a mouse. A user may also alter an image by, for instance changing colors, re-cropping, reorienting and resizing using, for instance, a pop up menu activated on moving a cursor over the key-image 42.

In a further method of using the GUI 36 to interact with key-images 42, a user may apply further binary and multi-image operations to the key-images 42 such as morphing one key-image 42 into another key-image 42 to produce a composite result image 48. The morphing operation may, for instance, be initiated using a mix slider bar 43. Use of the mix slider bar 43 may, for instance allow a composite of various percentages of one key-image 42 to morph into the other key-image 42. For instance, a man and woman could be morphed into a child image which can then be used to search a database. Although the GUI 36 and its functionality have been described primarily with respect to a computer display, one of ordinary skill will appreciate that the same or equivalent functionality may be readily designed into a variety of user interfaces including, but not limited to, a TV, a personal digital assistant and a wireless phone. In a further embodiment of the invention the features such as, but not limited to, the morphing feature, could be used by itself using, for instance, a cell phone or laptop for entertainment or other purposes. The morphing may be done using, for instance, well-known thin-plate spline image morphing equations and algorithms.

In a further method of using the GUI 36 to interact with key-images 42, a user may select two key-image 42 and have the system score them both by a similarity image map as described above or by numerical value. This may be preparation for a query or may used by itself for entertainment purposes. For instance, a cell-phone user may take an image of themselves and another person or object using their cell phone camera and then request a similarity score of the two images. This may be done for identification or for entertainment purposes.

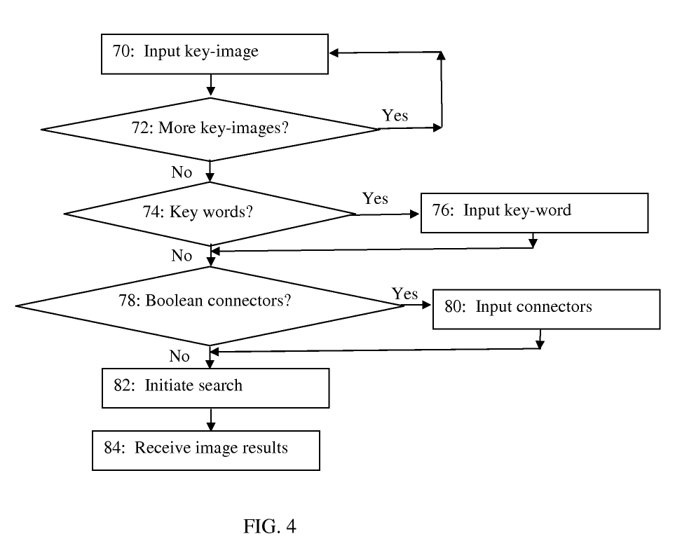

FIG. 4 is a flow diagram showing steps in using a system for multimedia searching using exemplar images.

In step 70, a user inputs a key-image 42 by some method such as, but not limited to, dragging-and-dropping a working image 52 from a working area 50 to a key-picture entry area 40, or by entering a text description in the key-picture entry area 40 or some combination thereof.

In step 72, the user decides if there are any more key-images 42 to be entered. If there are, the user returns to step 70. If not, the user then decides, in step 74, if there are any keywords to be used in the search string. If there are, the user proceeds to step 76 and enters the keywords using a keyboard, by cutting and pasting from a document or using a voice data entry system, or some combination thereof.

In step 78, the user decides if there are any Boolean operators needed to connect the key-images and key words into a search string. In a preferred embodiment, the default connector between key-images, keywords and key-images and key words may be the Boolean AND operator. If the user wants to change the default, they may proceed to step 80 and input operators using, for instance, selecting an option from a menu, selecting a button, a keyboard, by cutting and pasting from a document or using a voice data entry system, or some combination thereof.

In step 82, the user initiates the search by selecting a button, selecting an option from a menu, selecting an icon or entering a voice command, or some combination thereof. Initiating the search may result in the search string being sent to a remote ICE module 12 via a network 18.

In step 84, the result images 48 are received and displayed in a results area 46. The results are preferably displayed in an order of similarity to the key-image or the search string. The order of similarity is preferably determined, in part, using image edit distances as described in detail above, and in the co-pending application incorporated by reference above.

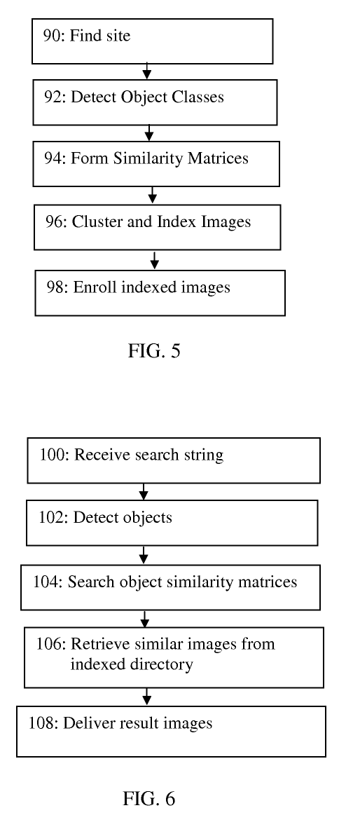

FIG. 5 is a flow diagram showing steps in forming an indexed database in an exemplary embodiment of a system for searching multimedia using exemplar images.

In step 90, the ICE module 12 locates a multimedia database that may, for instance, be a website connected to the Internet or some other network. Copies of the content may, for instance, be downloaded from the remote site to the ICE module 12.

In step 92, a suitable software module processes the contests of the multimedia database by, for instance, examining copies of the images and detecting instances of various classes of objects. This detection may, for instance, be made using trained SVM or SIM machines, as detailed above.

In step 92, a suitable software module forms similarity matrices of the various instances of the various classes of objects found in the multimedia database.

In step 96, the similarity matrices generated in step 92 may be clustered and added into a larger similarity matrix containing instances of the same class of object found at other databases. All the instances of objects are indexed so that the location they were originally detected in can be found easily, and so they can be found in the database.

In step 98 the indexed new images are enrolled into a storage database so that can be retrieved later.

FIG. 6 is a flow diagram showing steps in responding to a search request in an exemplary embodiment of a system for searching multimedia using exemplar images.

In step 100, the ICE module 12 receives a search string. The search string may be, but is not limited to, a combination of key-images, key words, Boolean operators and text attributes linked to the key-images.

In step 102, suitable software modules examine the key-images to detect generic objects. This detection may, for instance, be made using trained SVM or similarity inverse matrix (SIM) machines, as detailed above. The software module may also generate or obtain generic, or exemplar, images of any keywords.

In step 104, the images of the detected objects may be resized and adjusted for lighting and for any text attributes linked to them. The adjusted images may then be used to search for matching or similar images in one or more appropriate similarity matrices. The searching may, for instance, be undertaken using the Podilchuk similarity matrix fast search that is described in detail in the co-pending application incorporated by reference above. The exemplar images may also be used to search for matching or similar images in one or more appropriate similarity matrices. The results of the searches may then be combined using the Boolean logic operators to produce a set of results that may be ranked according to degree of match to the original search string. The ranking may, for instance, take the form of an order of similarity that is based, in part, on the image edit distances between the one or more key-images, the one or more exemplary images generated from the one or more keywords and the results images, and the Boolean operators.

In step 106, the images indicated by the set of results may then be retrieved from the database. Alternately, or as well, the URL of the original location of the images may be retrieved.

In step 108, the images indicted by the set of results may then be delivered to the user's computer. Alternately, or as well, the URL of the original location of the images may be delivered to the user's computer. The images or the URLs may also be linked to an indicator of their degree of match to the search string. This indicator may be a simple ranking, or a percentage match or some combination thereof. In a preferred embodiment, results are preferably returned along with an order of similarity to the key-image or the search string. The order of similarity may be determined, in part, using a image edit distance as described in detail above, and in the co-pending application incorporated by reference above.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present invention.

What is claimed is:

1. A method of searching a multimedia database, said method comprising the steps of:
providing a first key-image; and
receiving one or more result images ranked in an order of similarity to said first key-image and wherein said order of similarity is determined using an image edit distance between said first search image and said one or more result images.

2. The method of claim 1 further comprising the steps of providing a second key-image and a Boolean operator and wherein determining said order of similarity further comprises using said Boolean operator and image edit distances between said second key-image and said one or more result images.

3. The method of claim 1 further comprising the steps of providing a first keyword and a Boolean operator and wherein determining said order of similarity further comprises generating an exemplar image from said first keyword and using mage edit distances between said exemplar image and said one or more result images, and said Boolean operator.

4. A method of responding to a multimedia database search request, said method comprising the steps of:
receiving a first key-image;
determining an order of similarity to said first search image using image edit distances between said first search image and one or more result images; and
delivering said one or more result images ranked in said order of similarity.

5. The method of claim 4 further comprising the steps of receiving a second key-image and a Boolean operator and wherein said determining an order of similarity further comprises using image edit distances between said second key-image and said one or more result images, and said Boolean operator.

6. The method of claim 4 further the steps of receiving a first keyword and a Boolean operator; generating an exemplar image from said first keyword; and wherein said step of determining an order of similarity further comprises using image edit distances between said exemplar image and said one or more result images, and said Boolean operator.

7. The method of claim 4 further comprising the steps of detecting a class of object in said first key image; and searching a similarity matrix related to said detected class of object for one or more result images.

8. The method of claim 7 wherein said detecting a class of object uses a similarity inverse matrix.

9. The method of claim 7 wherein said searching a similarity matrix uses a Podilchuk similarity matrix fast search.

10. A computer-readable medium, comprising instructions for:
providing a first key-image; and
receiving one or more result images ranked in an order of similarity to said first key-image and wherein said order of similarity is determined using image edit distances between said first search image and said one or more result images.

11. The computer-readable medium of claim 10 further comprising instructions for providing a second key-image, a first keyword and one or more Boolean operators; generating an exemplar image from said first keyword; and wherein said order of similarity further comprises using image edit distance between said second key-image and said one or more result images, image edit distances between said exemplar image and said one or more result images, and said one or more Boolean operators.

12. A computer-readable medium, comprising instructions for:
receiving a first key-image;
determining an order of similarity to said first search image using image edit distances between said first search image and one or more result images; and
delivering said one or more result images ranked in said order of similarity.

13. The computer-readable medium of claim 12 further comprising instructions for receiving a second key-image, a first keyword and one or more Boolean operators; generating an exemplar image from said first keyword; and wherein said determining an order of similarity further comprises using said Boolean operator and image edit distances between said second key-image and said one or more result images and image edit distances between said exemplar image and said one or more result images.

14. The computer-readable medium of claim 12 further comprising the steps of detecting a class of object in said first key image using a similarity inverse matrix; and searching a similarity matrix related to said detected class of object for one or more results images using a Podilchuk similarity matrix fast search.

15. A computing device comprising: a computer-readable medium comprising instructions for:
providing a first key-image; a second key-image, a first keyword and one or more Boolean operators; and
receiving one or more result images ranked in an order of similarity and wherein said order of similarity is determined using said one or more Boolean operators and image edit distances between each of said first search image, said second search image and an exemplar image generated from said first keyword, and said one or more result images.

16. A computing device comprising: a computer-readable medium comprising instructions for:
receiving a first key-image, a second key image, a first keyword, and one or more Boolean operators;
generating an exemplar image from said first keyword;
determining an order of similarity to said first search image using said Boolean operators and image edit distances between each of said first search image, said second search image and said exemplar image and said one or more result images;
delivering one or more result images ranked in said order of similarity.

17. An apparatus searching a multimedia database, comprising:
means for providing a first key-image; and
means receiving one or more result images ranked in an order of similarity to said first key-image and wherein said order of similarity is determined using image edit distances between said first search image and said one or more result images.

18. An apparatus for responding to a multimedia database search request, comprising:
means for receiving a first key-image;
means for determining an order of similarity to said first search image using image edit distances between said first search image and one or more result images; and
means for delivering said one or more result images ranked in said order of similarity.

19. An system for searching a multimedia database, comprising:
a first key-image; and
one or more result images ranked in an order of similarity to said first key-image and wherein said order of similarity is determined using image edit distances between said first search image and said one or more result images.

20. A system for responding to a multimedia database search request, comprising:
a first key-image; and
one or more result images ranked in an order of similarity to said first search image determined using image edit distances between said first search image and said one or more result images.
